(19) United States
(12) Patent Application Publication
(10) Pub. No.: US 2006/0147831 A1
(43) Pub. Date: Jul. 6, 2006

(54) Two-component developer for electrophotography and developing method using same

(76) Inventors: Takayuki Hamanaka, Shizuoka-shi (JP); Moriyuki Goto, Shizuoka-shi (JP)

Correspondence Address: OLIFF & BERRIDGE, PLC, P.O. BOX 19928, ALEXANDRIA, VA, 22320, US

(21) Appl. No.: 10/545,675

(22) PCT Filed: Feb. 27, 2004
(86) PCT No.: PCT/JP04/02408

§ 371 Date: Aug. 15, 2005

(30) Foreign Application Priority Data
Feb. 28, 2003 (JP) 2003-054211

(51) Int. Cl. G03G 9/00

(52) U.S. Cl. 430/111.1

(57) ABSTRACT

A two-components developer for electrophotography comprises a toner containing at least cyclo-olefin copolymer resin as a binder resin and magnetic material dispersed resin carrier. It is desirable that the Vickers hardness of the toner be in a range from 19.0HV0.01 to 23.0HV0.01, and that the binder resin contain the cyclo-olefin copolymer resin in a range from 50 to 100 wt %. Furthermore, a developing method for electrophotography in which the two-components developer for electrophotography mentioned above is used, is also disclosed.

### TECHNICAL FIELD

The present invention relates to a two-components developer for electrophotography used in image-forming devices such as copy machines, printers, facsimile machines or the like in which electrophotography technology is used, and relates to a method for electrophotographic developing.

### BACKGROUND ART

As a dry-type developer used in image-forming devices in which electrophotographic technology is used, there are basically three kinds of developers, that is, a two-components developer having a toner and a carrier such as ferrite powder, iron powder, glass beads or the like, a magnetic one-component developer having a toner containing magnetic powder therein, and a non-magnetic one-component developer. A toner used in these developers contains binder resin and coloring agent as main components, and further contains wax to improve fixability to recording sheets at low temperatures and releasability at a fusing member, and a charge controlling agent to add polarity (positive charge or negative charge). The toner is prepared by mixing these materials in predetermined ratio, by forming into powder by melt kneading, pulverizing, classifying and the like, and finally, by performing surface treatment using silica, titanium oxide, alumina, and kinds of resin fine particles to control properties of flowing, charging, cleaning, and storage stability.

As the binder resin of toner, styrene-acrylic acid ester based copolymer resin or polyester based resin is mainly used. However, in the case in which the styrene-acrylic acid ester based copolymer resin is used in a toner, environmental resistance is superior, but breaking strength is low, and fine powder is easily generated. Furthermore, in the case in which the polyester based resin is used in a toner, breaking strength is high and fine powder is hardly generated, but environmental resistance is inferior.

As a binder resin for toner which has recently attracted attention, cyclo-olefin copolymer resin can be mentioned, and a toner including such resin is disclosed in Japanese Unexamined Patent Application Publications No. Hei 09-101631 and No. 2000-284528, for example.

Recently, since electrophotography is required to be of high image quality (such as ability to reproduce thin lines and tone), ferrite carrier or magnetic material dispersed resin carrier in which high quality images can be obtained by reducing magnetic force of the carrier is desirably used in a two-components developer. Furthermore, from the viewpoint of increasing the life of the developer, magnetic material dispersed resin carrier is desirably used since the specific gravity of magnetic material dispersed resin carrier is low and close to that of the toner, mixing of carrier and toner is easy, stress on the toner is not generated so much, and fine particles and carrier spent are hardly generated. Furthermore, since the magnetic material dispersed resin carrier generally has small diameter compared to the diameter of ferrite carrier, it is desirably used to direct further improvement of images.

However, in the case in which particle diameter of the carrier is small, the number of times of toner particle contact is increased and the toner is easily broken, resulting in toner dusting. Furthermore, the toner is highly charged by friction, charges of neighboring toner particles may be absorbed by the highly charged toner to generate low-charge toners, and toner dusting may occur in developing devices.

### DISCLOSURE OF THE INVENTION

The present invention was completed in view of the above circumstances, and an object of the present invention is to provide a two-components developer for electrophotography having an ability to form high quality image, an ability to reduce toner dusting and fogging, superior environmental resistance, and long life, and a developing method using thereof.

The two-components developer for electrophotography of the present invention includes toner having at least cyclo-olefin copolymer resin as a binder resin, and a magnetic material dispersed resin carrier.

The cyclo-olefin copolymer resin contained in the toner of the two-components developer for electrophotograpy of the present invention has a lower specific gravity and higher intrinsic volume resistance compared to styrene-acrylic acid ester based copolymer resin or polyester based resin which have been used conventionally. Therefore, it has superior properties for developing and transferring (transferring efficiency), and it can print more sheets per unit weight of toner (i.e., consumes less toner). Furthermore, since the breaking strength of the resin is high, breaking of toner can be reduced, and therefore, not only can toner dusting be reduced but the life of developer also be extended. Furthermore, the resin is hardly influenced by temperature or humidity, and so it has superior environmental resistance. Furthermore, since the resin has superior light transparency, it can also be used as a resin for a full-color toner.

Since the specific gravity of the magnetic material dispersed resin carrier of the two-components developer for electrophotography of the present invention is low and close to that of the toner, carrier and toner can be mixed easily, and the carrier and the toner can be mixed without nonuniformity. Since the surface of the carrier is made of resin, little stress is applied on the toner, and toner breaking and carrier spent can be reduced.

### THE BEST MODE FOR CARRYING OUT THE INVENTION

The present invention is further explained below.

The toner used in the present invention consists of at least toner particles, and a fluidizing agent such as hydrophobic silica can be added if necessary. The toner particle contains cyclo-olefin copolymer resin as a binder resin, and if necessary, a coloring agent, releasing agent, charge controlling agent, or the like can be added.

In the toner particle of the present invention, the binder resin is required to contain at least cyclo-olefin copolymer resin. The cyclo-olefin copolymer resin is a polyolefin resin having a ring structure unit, for example, a copolymer of α-olefin such as ethylene, propylene, butylene, or the like (acyclic olefin) and cyclo-olefin having double bonds such as cyclohexene, norbornene, tetracyclododecene, or the like. The copolymer can be a random copolymer or block copolymer. These cyclo-olefin copolymers can be obtained by a conventional polymerizing method in which metallocene based or Ziegler based catalyst is used. In addition, the cyclo-olefin copolymer can be modified by introducing a carboxylic group. For example, methods disclosed in Japanese Unexamined Patent Application Publication No. Hei 05-339327, No. Hei 05-9223, and No. Hei 06-271628 can perform to synthesize the copolymer.

In the present invention, one kind of the cyclo-olefin copolymer resin obtained by the above-mentioned method can be used, or a mixture of plural kinds of cyclo-olefin copolymer resins having different average molecular weight can be used.

In the present invention, other kinds of resins can be used with the above-mentioned cyclo-olefin copolymer resin in the binder resin. The ratio of the cyclo-olefin copolymer resin in the binder resin is desirably in a range from 50 to 100 wt %, and more desirably in a range from 80 to 100 wt %. In the case in which the ratio of the cyclo-olefin copolymer resin is less than 50 wt %, it will be difficult to provide toner for electrophotography, which can maintain sufficient image density under any environment, does not generate toner dusting, does not generate problems of black spots (hereinafter referred to as “BS”) generated by film forming on the photoreceptor and contamination on developing members, and have high developing property, high transferring property, and low consumption amount, when a large number of copies is made.

As other resins which can be used with the cyclo-olefin copolymer resin, polystyrene resin, polyacrylic acid ester resin, styrene-acrylic acid ester copolymer resin, styrene-methacrylic acid ester copolymer resin, polyvinyl chloride, polyvinyl acetate, polyvinylidene chloride, phenol resin, epoxy resin, polyester resin, hydrogenated rosin, cyclized rubber, polylactic acid resin, terpene phenol resin, polyolefin resin or the like can be mentioned. In particular, a resin which can have increased toner viscosity when melted is desirable to prevent paper wrapping to fusing roller when the toner is fused. Therefore, it is desirable that the melting start temperature (softening point) be relatively high (e.g., from 120 to 150° C.), and that the glass transition temperature be not less than 65° C. to improve storage stability.

In the present invention, it is desirable that wax be contained to improve fixability at low temperature and releasability at fusing. In particular, it is desirable in the case in which molecular weight of the cyclo-olefin copolymer resin is large, to compensate the fixability at low temperature. As the wax, polyolefin based wax such as polyethylene wax, polypropylene wax or the like, synthesized wax such as Fischer-Tropsch wax or the like, petroleum wax such as paraffin wax, microcrystalline wax or the like, carnauba wax, candelilla wax, rice wax, hydrogenated castor oil or the like can be mentioned. In addition, for the purpose of controlling micro-dispersion of wax in the cyclo-olefin copolymer resin, it is desirable to use modified polyethylene wax. Two or more kinds of these waxes can be used together. The content of the wax is desirably in a range from 0.5 to 10.0 wt % in the toner particle, and more desirably in a range from 1.0 to 8.0 wt %. In the case in which the amount is less than 0.5 wt %, fixability at low temperature and releasability at fusing is not sufficient, and in the case in which the content amount is more than 10.0 wt %, storage stability is not sufficient.

Plural kinds of wax can be used if necessary, and it is desirable that all the waxes used have melting points shown by endothermic peak of DSC in a range from 80 to 160° C. In the case in which the melting point is less than 80° C., blocking of toner particles easily occurs and there is a problem of durability, and in the case in which the melting point is more than 160° C., fixing strength is reduced.

The method of measuring of the melting point (endothermic peak of DSC) is as follows. About 10 mg of a sample was placed in an aluminum cell, the cell was placed in differential scanning calorimeter (DSC) (trade name: SSC-5200, produced by Seiko Instruments Inc.), and N₂ gas was blown at 50 ml per minute. A process in which the temperature was increased from 20 to 180° C. at a rate of 10° C. per minute and then decreased from 180 to 20° C. rapidly, was repeated two times, and the endothermic peak temperature at that time (i.e. the second time) was measured.

As a black pigment for the coloring agent, carbon black or lamp black can be mentioned, as a magenta pigment, C. I. pigment red 1, 2, 3, 4, 5, 6, 7, 8, 9, 10, 11, 12, 13, 14, 15, 16, 17, 18, 19, 20, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207, 209; C. I. pigment violet 19; C. I. violet 1, 2, 10, 13, 15, 23, 29, 35 or the like can be mentioned, as a cyan pigment, C. I. pigment blue 2, 3, 15, 16, 17; C. I. vat blue 6; C. I. acid blue 45 or the like can be mentioned, and as a yellow pigment, C. I. pigment yellow 1, 2, 3, 4, 5, 6, 7, 10, 11, 12, 13, 14, 15, 16, 17, 23, 65, 73, 74, 83, 97, 155, 180 or the like can be mentioned. These are used alone or in combination. As a coloring agent which is commonly used, carbon black, aniline blue, calco oil blue, chrome yellow, ultramarine blue, Dupont oil red, quinoline yellow, methylene blue chloride, phthalocyanine blue, malachite green oxalate, lamp black, rose bengal or the like can be mentioned. The coloring agent is required to be sufficiently contained to form visible images having sufficient density. For example, it may be contained in a range from about 1 to 20 parts by weight, desirably in a range from 1 to 7 parts by weight, to 100 parts by weight of the binder resin.

The toner used in the present invention desirably contains a charge controlling agent if necessary. The charge controlling agent is added to add polarity, there are two kinds of charge controlling agent such as those for positively charged toner and for negatively charged toner. As a charge controlling agent for positively charged toner, nigrosine dye, quaternary ammonium salt, pyridinium salt, azine, low molecular weight polymer having cationic functional group (e.g., trade name: FCA201-PS, produced by Fujikura Kasei Co., Ltd.), and the like can be mentioned. As a charge controlling agent for negatively charged toner, azo-type metal complex, salicylic acid type metal complex, boron-type complex, low molecular weight polymer having anionic functional group (e.g., trade name: FCA-1001-NS, produced by Fujikura Kasei Co., Ltd.), and the like can be mentioned. Desirable contained amounts thereof are in a range from 0.1 to 5 parts by weight to 100 parts by weight of binder resin. They can be used alone or in combination. It is desirable to use a colorless one for full color toners. Boron type complexes, zinc complexes, and chromium complexes are colorless, and in particular, a boron type complex is desirable. For example, LR-147 produced by Japan Carlit Co., Ltd., is commercially available.

As other additive agents which can be added if necessary, magnetic powder or the like can be mentioned. As the magnetic powder, fine particles of ferrite powder, magnetite powder, iron powder or the like can be mentioned. As the ferrite powder, mixed-sintered material of MeO—Fe₂O₃ can be used. In this case, MeO is an oxide of Mn, Zn, Ni, Ba, Co, Cu, Li, Mg, Cr, Ca, V or the like, and one or more kinds thereof can be used. As the magnetite powder, mixed-sintered material of FeO—Fe₂O₃ can be used. Particle diameter of the magnetic powder is desirably in a range from 0.05 to 3 μm, and the contained ratio is desirably not more than 30 wt % in the toner.

Toner particles used in the toner of the present invention can be produced by mixing the above-mentioned raw materials in predetermined ratios, melting and kneading the mixture, pulverizing into powder form, and classifying. Alternatively, the toner particle can be produced by performing a polymerizing method using raw materials of the above mentioned material. Volume average particle diameter of the toner particle is generally set in a range from 5 to 15 μm.

Hydrophobic silica fine particles as fluidizing agent is desirably adhered to the toner particles in a range from 0.5 to 3.0 wt %, and more desirably in a range from 0.7 to 2.5 wt %. In the case in which the adhered amount of the hydrophobic silica fine particle is less than 0.5 wt %, releasing agent contained in the toner particle is adhered to photoreceptors or charging members, and image defects may easily occur. In the case in which the adhered amount is more than 3.0 wt %, the hydrophobic silica may easily fall off from the toner particles, and BS on photoreceptor may be generated. Furthermore, the average particle diameter of hydrophobic silica fine particle is desirably less than 0.10 μm. In addition, particles of large diameter, medium diameter, and small diameter can be used in combination if necessary. In this way, more reliable properties of adhesion resistance can be obtained.

In addition, magnetic powder, alumina, talc, clay, calcium carbonate, magnesium carbonate, titanium oxide, or some kinds of resin particles can be adhered to the toner to control flowing properties, charging properties, cleaning properties, and storage stability of the toner.

To adhere the above-mentioned fine particles on the toner particles, a method in which a commonly used agitator such as a turbine-type agitator, Henschel mixer, super mixer or the like is used, can be mentioned.

Vickers hardness of the toner particles of the present invention is desirably in a range from 19.0 to 23.0 HV0.01.

In the case in which the Vickers hardness is less than 19.0, breaking strength of the toner is decreased, the toner is easily broken, and fogging occurs easily. On the other hand, in the case in which the Vickers hardness is more than 23.0, the toner becomes harder, and repulsive force is increased, amount of charge is increased, and satisfactory image density is difficult to obtain.

The Vickers hardness of the toner can be controlled by molecular weight distribution of binder resin, kinds and content of additive agents, and conditions of melting, and kneading.

The Vickers hardness was measured by the following method.

A sample was pressed to be hardened by a high-pressure pressing device at 500 kg/cm². Depending on a method disclosed in Japanese Industrial Standard Z2244: 1998, the Vickers hardness HV0.01 of the sample was measured at force of examination of 0.09807 N, under conditions of 23° C. and 55% RH.

The two-components developer for electrophotography of the present invention contains magnetic material dispersed resin carrier as a carrier, and the magnetic material dispersed resin carrier of the present invention is explained further below.

As a resin used in the magnetic material dispersed resin carrier, the one of the following is desirably used, but it is not limited in particular.

As such a resin, phenol based resin, styrene based resin, acrylic based resin, styrene/acrylic based resin, olefin based resin, halogen based vinyl polymer, vinyl ester based polymer, polyester resin, polyurethane resin, epoxy resin, silicone resin, melamine resin or the like can be used. Furthermore, a modified resin of the above-mentioned resin such as urethane modified silicone resin, and urethane modified polyester resin can be used.

As a magnetic material, all the magnetic materials ordinarily used can be used. As the magnetic material, strong magnetic oxide such as ferrite, magnetite or the like, strong magnetic metal such as iron, cobalt, nickel or the like, or other magnetic compound or alloy can be mentioned.

Weight average particle diameter of the magnetic material is desirably in a range from 10 to 60 μm to obtain a carrier having desirable particle diameter. The weight average particle diameter was measured according to Japanese Industrial Standard Z8815.

The contained ratio of the magnetic material is desirably in a range from 50 to 95 wt % of the carrier weight, and more desirably in a range from 70 to 90 wt %. In the case in which the ratio is less than 50 wt %, magnetic properties are insufficient, carrier scattering from the developing sleeve may occur, and carrier may easily adhere to the photoreceptor. In the case in which the ratio is more than 95 wt %, surface strength of the carrier is reduced, and specific gravity of the carrier is increased.

In the carrier of the present invention, charge controlling agent, electrical resistance controlling agent, filler or the like can be added to control charging and electrical resistance and to improve strength.

Any conventional method can be employed to produce the magnetic material dispersed resin carrier of the present invention. For example, the above-mentioned binder resin and magnetic material, and if necessary, other additives such as carbon black, charge controlling agent, inorganic fine particles or the like, may be mixed sufficiently, and melted and kneaded. The mixture is crushed coarsely and then finely into particles, and the particles are classified in desirable diameter.

The magnetic material dispersed resin carrier of the present invention obtained above desirably has a weight average particle diameter in a range from 15 to 60 μm, and more desirably in a range from 20 to 50 μm. In the case in which the diameter is less than 15 μm, the carrier may easily adhere the photoreceptor, and in the case in which the diameter is more than 60 μm, it will become difficult to obtain high quality images.

The two-components developer for electrophotography of the present invention comprises toner containing at least cyclo-olefin copolymer resin as a binder resin, and magnetic material dispersed resin carrier in a mixed state. It should be noted that concentration of the toner in the developer is desirably in a range from 1 to 20 wt %. In the case in which the concentration is less than 1 wt %, the amount of charge becomes excessive, and in the case in which the concentration is more than 20 wt %, toner dusting may easily occur.

The present invention is further explained by way of Examples and Comparative Examples. However, the present invention is not limited in the range thereto.

Preparation of Cyclo-Olefin Copolymer Resins A to F

Two or more kinds of cyclo-olefin copolymer resin having mutually different molecular weight distribution (trade name: TOPAS COC, produced by Ticona GmbH) were blended by varying the ratio thereof, they were formed into pellets to obtain cyclo-olefin copolymer resins A to F.

### EXAMPLE 1

Preparation of Toner A

Raw materials having ratios shown below were premixed by a super mixer for 5 minutes, heat melted and kneaded by a biaxial extruder, pulverized by a jet mil, and classified by a dry-type air flow classifier, to obtain toner particles having volume average particle diameter of 8 μm. 0.5 wt % of hydrophobic silica (trade name: R-976, produced by Nippon Aerosil Co., Ltd., average particle diameter: 0.012 μm) was added to the obtained toner particles and they were mixed by a Henschel mixer for 3 minutes at a circumferential velocity of 40 m/sec, to obtain toner A.

| | | |
|---|---|---|
| Cyclo-olefin copolymer resin A | 100 | parts by weight |
| Polypropylene wax (trade name: | 3 | parts by weight |
| Viscol 660p, produced by SANYO | | |
| Chemical Industries, Ltd., | | |
| melting point: 136.9° C.) | | |
| Charge controlling agent (trade | 1 | part by weight |
| name: T-77, produced by Orient | | |
| Chemical Industries, Ltd.) | | |
| Carbon black (trade name: | 5 | parts by weight |
| Mitsubishi Carbon #25, produced by | | |
| Mitsubishi Chemical Corporation) | | |

Preparation of Magnetic Material Dispersed Resin Carrier

Raw materials having ratios shown below were sufficiently mixed by a Henschel mixer, heat melted and kneaded by a vent biaxial extruder at 160° C., crushed coarsely by a feather mil, pulverized finely by a mechanical grinder, and classified by a air classifier to obtain a magnetic material dispersed resin carrier having weight average particle diameter of 45 μm.

| | |
|---|---|
| Magnetic material (trade name: | 300 parts by weight |
| F-300, ferrite produced by Powdertech | |
| CO., LTD., weight average particle | |
| diameter: 40 μm) | |
| Styrene-Acrylic resin (glass | 100 parts by weight |
| transition temperature Tg: 63° C., | |
| softening point Tm: 131° C.) | |

Preparation of Developer A

5 parts by weight of the toner A and 95 parts by weight of the above-mentioned magnetic material dispersed resin carrier were mixed to obtain developer A.

### EXAMPLE 2

Preparation of Toner B and Developer B

Except that cyclo-olefin copolymer resin B was used instead of the cyclo-olefin copolymer resin A, toner B and developer B were produced in a manner similar to that in Example 1.

### EXAMPLE 3

Preparation of Toner C and Developer C

Except that cyclo-olefin copolymer resin C was used instead of the cyclo-olefin copolymer resin A, toner C and developer C were produced in a manner similar to that in Example 1.

### EXAMPLE 4

Preparation of Toner D and Developer D

Except that cyclo-olefin copolymer resin D was used instead of the cyclo-olefin copolymer resin A, toner D and developer D were produced in a manner similar to that in Example 1.

### EXAMPLE 5

Preparation of Toner E and Developer E

Except that cyclo-olefin copolymer resin E was used instead of the cyclo-olefin copolymer resin A, toner E and developer E were produced in a manner similar to that in Example 1.

### EXAMPLE 6

Preparation of Toner F and Developer F

Except that cyclo-olefin copolymer resin F was used instead of the cyclo-olefin copolymer resin A, toner F and developer F were produced in a manner similar to that in Example 1.

### COMPARATIVE EXAMPLE 1

Preparation of Toner G and Developer G

Except that polyester resin (trade name: FC-1142, produced by Mitsubishi Rayon Co., Ltd.) was used instead of the cyclo-olefin cololymer resin A as the binder resin, toner G and developer G were produced in a manner similar to that in Example 1.

### COMPARATIVE EXAMPLE 2

Preparation of Toner H and Developer H

Except that polyester resin (trade name: FC-316, produced by Mitsubishi Rayon Co., Ltd.) was used instead of the cyclo-olefin cololymer resin A as the binder resin, toner H and developer H were produced in a manner similar to that in Example 1.

### COMPARATIVE EXAMPLE 3

Preparation of Developer I

Toner A was used, and except that a commercially available coated ferrite carrier (trade name: F97-2035, produced by Powdertech Corporation) was used, developer I was produced in a manner similar to that in Example 1.

Vickers hardness of each resin and toner measured by the above-mentioned measuring method is shown in Table 1.

TABLE 1

| | Vickers hardness | Vickers hardness |
|---|---|---|
| | of Binder | of Toner |
| | resin (HV0.01) | (HV0.01) |
| Example 1 | 18.8 | 20.2 |
| Example 2 | 18.6 | 19.2 |
| Example 3 | 21.0 | 22.1 |
| Example 4 | 15.8 | 17.2 |
| Example 5 | 22.2 | 23.4 |
| Example 6 | 16.3 | 18.0 |
| Comparative Example 1 | 17.4 | 18.6 |
| Comparative Example 2 | 18.1 | 19.9 |
| Comparative Example 3 | 18.8 | 20.2 |

Evaluation of Developer

Using a commercially available copy machine for two-components developing (trade name: Di-181, produced by Minolta CO., LTD.), copying was performed 20,000 times continuously, and image density (ID), Fogging (BG), toner dusting were evaluated (environmental condition: 20° C., 20% RH).

Image density (ID) was evaluated by measuring solid image by a Macbeth reflection densitometer (trade name: RD-914).

Fogging (BG) was evaluated by measuring whiteness of the non-image parts before and after copying by a color meter (trade name: ZE2000, produced by Nippon Denshoku Industries Co., Ltd.), and the whiteness values thereof were compared.

Toner dusting was evaluated by taking off toner which was scattered on to the outside surface corresponding to a lower part of the developer holding roller in the developing device by an adhesive tape (produced by Sumitomo 3M Limited), and compared by visual observation. Evaluation result is shown in Table 2.

TABLE 2

| | | | | After 10,000 | | After 20,000 copies | | |
|---|---|---|---|---|---|---|---|---|
| | | Initial | | copies | | | | Toner |
| | Toner | ID | BG | ID | BG | ID | BG | dusting |
| Example 1 | A | 1.45 | 0.55 | 1.39 | 0.42 | 1.40 | 0.50 | ◯ |
| Example 2 | B | 1.46 | 0.57 | 1.45 | 0.70 | 1.46 | 0.77 | ◯ |
| Example 3 | C | 1.44 | 0.76 | 1.37 | 0.45 | 1.36 | 0.48 | ◯ |
| Example 4 | D | 1.45 | 0.52 | 1.38 | 0.87 | 1.35 | 1.02 | Δ |
| Example 5 | E | 1.45 | 0.59 | 1.35 | 0.69 | 1.31 | 0.50 | ◯ |
| Example 6 | F | 1.43 | 0.61 | 1.34 | 0.94 | 1.36 | 0.87 | Δ |
| Comparative | G | 1.47 | 0.86 | 1.39 | 1.25 | 1.36 | 1.51 | X |
| Example 1 | | | | | | | | |
| Comparative | H | 1.42 | 0.80 | 1.33 | 1.57 | 1.02 | 3.51 | X |
| Example 2 | | | | | | | | |
| Comparative | A | 1.39 | 1.66 | * | * | * | * | * |
| Example 3 | | | | | | | | |

◯: No dusting,
Δ: Some dusting, by no practical problem,
X: Substantial dusting
*: Copying was stopped since initial BG was large

As is clear from Table 2, toner dusting was not observed and image density and fogging from the first to the 20,000th copy were good in Examples 1 to 3. In Example 4, some toner dusting was observed and fogging was somewhat much since Vickers hardness was low and the toner was easily broken; however, it can be usable in practice. In Example 5, toner dusting was not observed; however, the toner had a tendency to be difficult to transfer and image density was decreased during the continuous copying since Vickers hardness was high; however, it can be usable in practice. In Example 6, similar tendencies as in Example 4 were observed since the Vickers hardness was low.

In Comparative Example 1, contamination due to toner dusting was observed on both sides of a printed image after at copying 10,000 times, and fogging was substantial since the Vickers hardness was low and polyester resin having low environmental resistance was used. In Comparative Example 2, the Vickers hardness was within the desirable range of the present invention; however, environmental resistance was deteriorated since polyester resin was used, image density was decreased during the continuous copying, and fogging was substantial. In Comparative Example 3, since fogging was substantial from the beginning, examination at 10,000 and 20,000 times could not be performed.

As explained above, the two-components developer for electrophotography and developing method using thereof in which high quality images are produced, toner dusting and fogging are minimized, and superior environmental resistance and long life are exhibited, can be provided by the present invention.

1. A two-components developer for electrophotography comprising:
a toner containing at least cyclo-olefin copolymer resin as a binder resin; and
a magnetic material dispersed resin carrier.

2. The two-components developer for electrophotography according to claim 1, wherein the toner has a Vickers hardness in a range from 19.0HV0.01 to 23.0HV0.01.

3. The two-components developer for electrophotography according to claim 1, wherein the magnetic material dispersed resin carrier has a weight average particle diameter in a range from 15 to 60 μm.

4. A developing method for electrophotography in which the two-components developer for electrophotography according to claim 1 is used.

5. The two-components developer for electrophotography according to claim 1, wherein the binder resin contains the cyclo-olefin copolymer resin in a range from 50 to 100 wt %.

6. The two-components developer for electrophotography according to claim 1, wherein the toner contains wax having a melting point in a range from 80 to 160° C.

7. The two-components developer for electrophotography according to claim 1, wherein hydrophobic silica fine particles as a fluidizing agent adheres to the toner particles in a range from 0.5 to 3.0 wt %.

8. The two-components developer for electrophotography according to claim 1, wherein weight average particle diameter of the magnetic material contained in the magnetic material dispersed resin carrier is in a range from 10 to 60 μm.

9. The two-components developer for electrophotography according to claim 1, wherein the contained ratio of the magnetic material in the magnetic material dispersed resin carrier is in a range from 50 to 95 wt % of the weight of the carrier.
